(19) United States
(12) Patent Application Publication
(10) Pub. No.: US 2003/0025259 A1
(43) Pub. Date: Feb. 6, 2003

(54) Vacuum holddown device

(76) Inventor: Dale Peterson Nesbit, Henderson, KY (US)

Correspondence Address: Lawrence E. Laubscher, Sr., EFS Customer No. 30267311, Suite 300, 745 South 23rd Street, Arlington, VA, 22202-2451, US

(21) Appl. No.: 09/917,957

(22) Filed: Jul. 31, 2001

(51) Int. Cl. B25B 11/00

(52) U.S. Cl. 269/21

(57) ABSTRACT

A vacuum holddown device for retaining a workpiece at a desired machining location on a horizontal work support surface, including a plurality of cylindrical actuators arranged in cavities contained in the upper surface of the work support. E ach of the actuators includes a vertically displaceable sensor member having a rounded surface that protrudes upwardly above the upper work support surface for engagement by the workpiece. When the sensor is depressed by the workpiece, a vacuum chamber in the actuator applies suction to the workpiece to maintain the same in the machining location. The actuators are selectively operable between flush and elevated positions relative to the work support. Attachment members may be selectively connected with the cylindrical actuators.

### SPECIFICATION

### FIELD OF THE INVENTION

The present invention relates to a holddown device for machining workpieces, and more particularly to a holddown device which utilizes a vacuum source to maintain a workpiece against a work surface upon the activation of at least one actuator arranged adjacent on the work surface.

### BACKGROUND OF THE INVENTION

### BRIEF DESCRIPTION OF THE RELATED ART

Various types of vacuum holddown devices for workpieces have been proposed in the patented prior art, as evidenced by the patents to Greene No. 4,946,149, Schmalz No. 6,095,506, and Moran No. 5,987,729.

In Greene a holddown device is disclosed that retains materials horizontally by stops and vertically by suction chucks. A configuration to support a given workpiece to be machined is manually determined and then manually programmed into the machine, thereby allowing the holddown device to machine workpieces of identical dimensions in a rapid succession. However, this design does not allow for automatically configuring the various stops to adjust to different sized workpieces. The present invention is not manually programmed, but rather reacts to the dimensions of the material, thereby allowing the manufacturing of workpieces of different size and shape without having to manually adjust stops on the work surface.

In the Schmalz patent, a vacuum holddown device is disclosed in which vacuum suction devices must be configured to match the dimensions of the workpiece. The present invention eliminates the configuration requirement by providing actuators throughout the work support. The actuators control when the vacuum pressure engages the workpiece through the work support.

Moran discloses a work support with a plurality of vacuum apertures which are continuously engaged with the vacuum pressure. Additionally, the Moran patent utilizes stops that are manually placed on the work surface, thereby requiring set up time. The present invention was developed to provide an improved device in which a vacuum force to the specific area of the work surface where an actuator is activated, thereby utilizing the vacuum force more efficiently. Further, the actuators of the present invention can be adjusted to various heights and act as stops for the workpiece, thereby eliminating the need for additional pieces which need to be applied to the work surface to act as stops as disclosed in the Moran reference. The actuators also continue to provide an active vacuum source when the actuator is in an adjusted, heightened position.

### SUMMARY OF THE INVENTION

The improved holddown device according to the present invention is characterized by the provision of a work support that contains at least one cavity within which an actuator means is arranged for engagement by a workpiece, thereby to hold the workpiece by suction on the work support. The actuator means includes an actuator housing which is adjustably arranged at different heights relative to the work support. When the actuator housing is arranged at a first height above the work surface, the actuator housing acts as a stop for the overall work support and can thereby position a workpiece in a desired location. Additionally, the actuator means continuously connects a vacuum chamber in the actuator housing with a vacuum source when the actuator housing is in one of a plurality of raised positions, thereby permitting the machining of workpieces of various shapes. An actuator sensor member is arranged within, and protrudes outwardly from, the actuator housing. When a workpiece is placed on one side of the work support, the workpiece activates the actuator tip, thereby to produce a vacuum force to hold the workpiece on the work support. The actuator sensor member is biased outwardly from the actuator housing by a compression spring. The tension of the spring and the resulting biasing force on the actuator tip sensor member is adjustable, thereby to control the activation force required to activate and engage the actuator sensor member to allow a vacuum force to be applied to a workpiece. Additionally, the actuator sensor member includes a sphere which provides a surface for easily sliding a workpiece across the work support. Further, a plurality of attachment accessories may be selectively attached to the upper side of the actuator to provide the capability to machine workpieces of various shapes.

According to a more specific object of the invention, an actuator housing is selectively displaceable relative to the work support between flush and elevated positions, rise being made of a C-shaped slot having a pair of horizontal leg portions joined by a vertical portion. The housing is spring-biased upwardly toward the elevated position, and is mounted for displacement relative to an annular mounting ring that is mounted in a cavity contained within the upper surface of the work support. To adjust the position of the cylindrical housing, it is rotated through 90° to position a radially inwardly directed pin on the mounting ring opposite the vertical connecting portion of the slot, whereby the housing may be axially displaced relative to the mounting ring.

According to another feature of the invention, various attachments may be connected with a quick-release quarter-turn bayonet type connection regardless of whether the housing is in it flush or elevated positions.

The opening in the upper end of the suction chamber is normally closed by a spherical sensor having a rounded surface that protrudes through the opening when the sensor is in the closed position, whereby the sphere is displaced downwardly toward the open position when a workpiece is mounted on the work support.

### BRIEF DESCRIPTION OF THE DRAWINGS

Other objects and advantages of the invention will become apparent from a study of the following specification when viewed in the light of the accompanying drawings, in which:

FIG. 1 is a partly sectioned detailed view of the actuator means of the present invention mounted in a cavity contained in a work support;

FIG. 2 is an exploded view of the actuator means of FIG. 1, and FIG. 2A is a detailed elevational view of the cylindrical housing of the actuator means of FIG. 2;

FIGS. 3 and 4 are sectional views of the actuator means with the sensor member in the closed and open positions, respectively;

FIG. 5 is a detailed sectional view illustrating the cylindrical housing of the actuator means in the elevated position relative to the work support;

FIG. 6 is a sectional view illustrating the holddown system with one of the actuator housings in the elevated position, thereby serving as a positioning stop;

FIG. 7 is a sectional view illustrating the manner of adjusting the tension of the tensioning spring associated with the sensor member;

FIG. 8 is a perspective view illustrating the operation of certain of the actuator members as stops in positioning a pair of workpieces on the work support;

FIG. 9 is a sectional view illustrating the manner for transporting a workpiece from a transfer system to the work support;

FIG. 10 is a detailed sectional view illustrating the manner in which an attachment member is connected with the cylindrical housing of the adapter means;

FIG. 11 is a top plan view of the upper end of the cylindrical housing of FIG. 10;

FIGS. 12 and 13 are side elevation and bottom plan views, respectively, of the connector means of FIG. 11 for connecting an attachment member with the cylindrical housing; and

FIGS. 14-16 are partly sectioned views of three types of attachment members suitable for use with the embodiment of FIG. 10.

### DETAILED DESCRIPTION

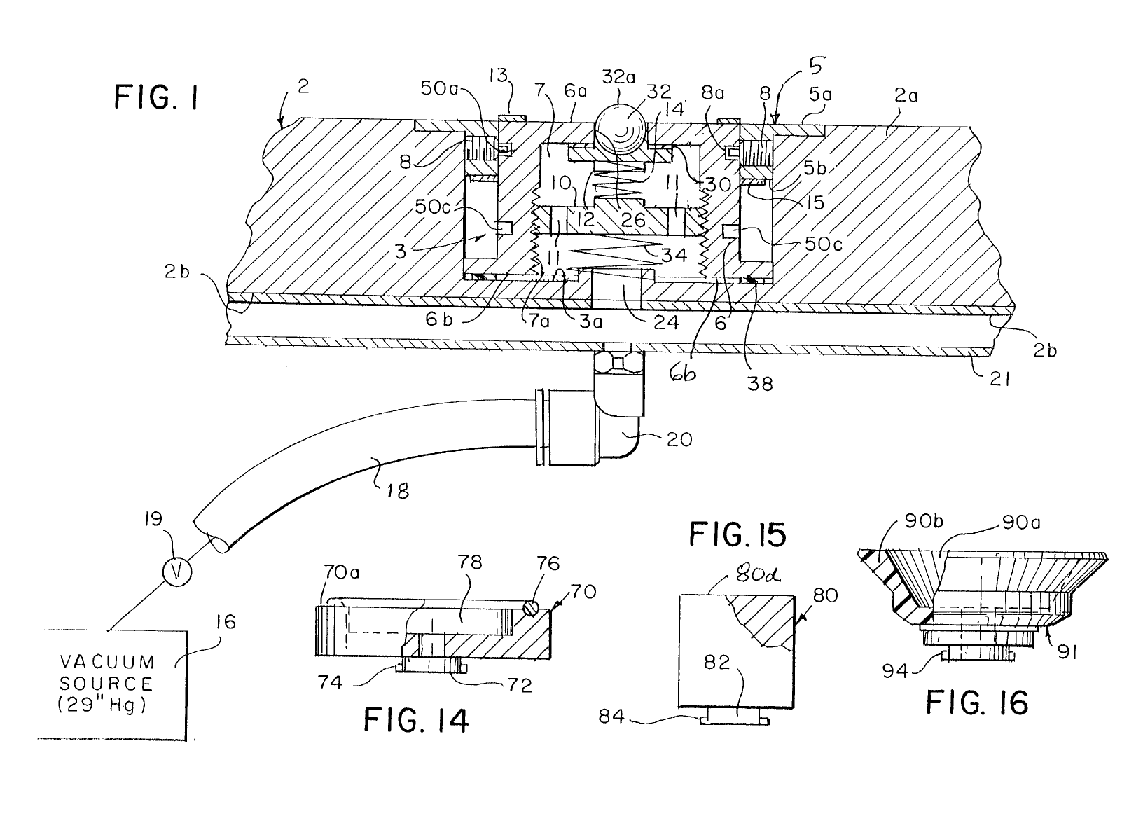

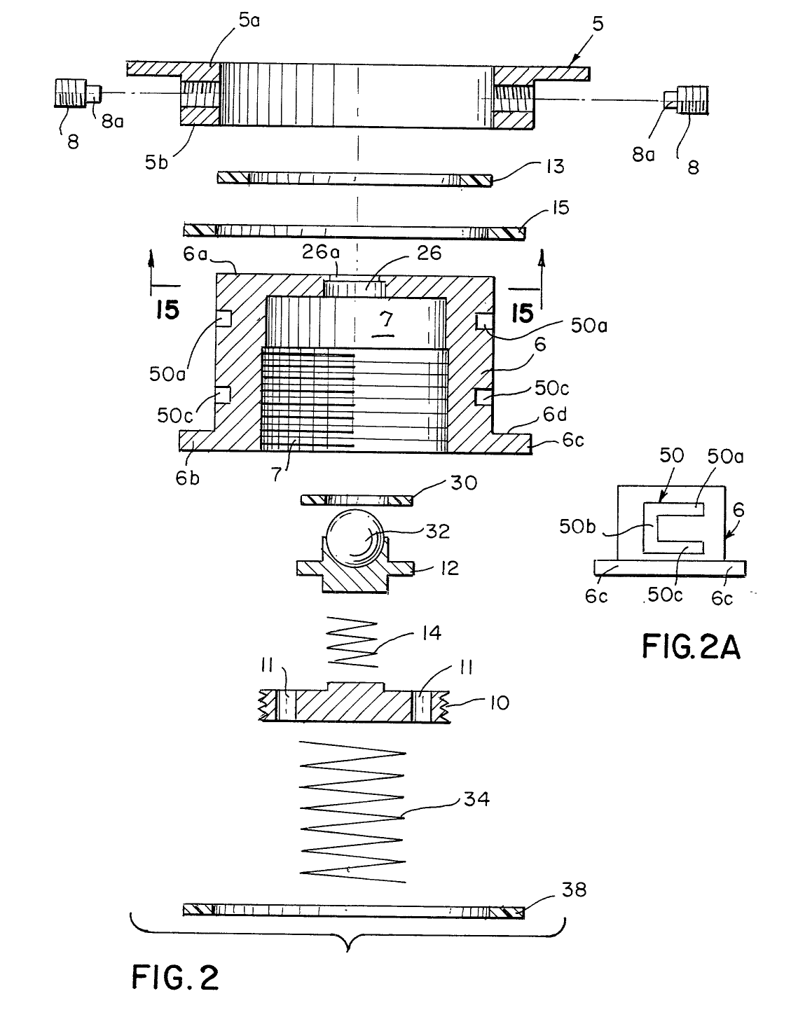

Referring first more particularly to FIGS. 1 and 2, the horizontal planar work station 2 has an upper surface 2a that contains a plurality of cavities or vertical bores 3 in which are mounted a plurality of suction actuator means 6 that define a plurality of suction stations, respectively. More particularly, in the upper end of each of the cavities 3 is mounted an annular support ring 5 having an upper surface 5a that is co-planar with the upper surface 2a of the work support 2. Slideably mounted for vertical displacement within the mounting ring 5 is a cylindrical housing 6 having upper and lower end surfaces 6a and 6b, respectively. The lower surface 6b contains a vacuum chamber 7, and the upper surface 6a of the housing contains an opening 26 that provides communication with the vacuum chamber 7. A vacuum source 16, having for example a negative pressure of about 29 inches mercury, is connected with the vacuum chambers of the cavities 3 by a conduit 18 containing shutoff valve 19, fitting 20, manifold 21, and openings 24 contained in the bottom surface 2b of the work support 2, respectively.

Mounted for movement within the vacuum chamber 7 is a sphere or ball 32 that is rotatably supported by a carrier 12. The sphere 32 is biased toward its illustrated closed position relative to the radially inwardly directed lip portion 26a of opening 26 by a first compression spring 14 that reacts between the carrier 12 and a tension adjusting disk 10 that is threadably connected with the interior peripheral wall of the cylindrical housing 6. The tension adjusting disk 10 is perforated to define passages 11 that maintain the vacuum chamber 7 in constant communication with the vacuum source 16 via the first opening 24. When the sphere 32 is in the illustrated closed position of FIG. 1, the vacuum chamber 7 is sealed by first annular seal means 30 arranged concentrically about the sphere carrier 12 for reaction between the carrier and the adjacent surface of the vacuum chamber. Second annular seal means 38 are arranged concentrically about the opening 24 between the bottom surface 6b of the cylindrical housing and the bottom wall 3a of the cavity 3. These annular seals are formed of a conventional seal material, such as neoprene or cell sponge seals.

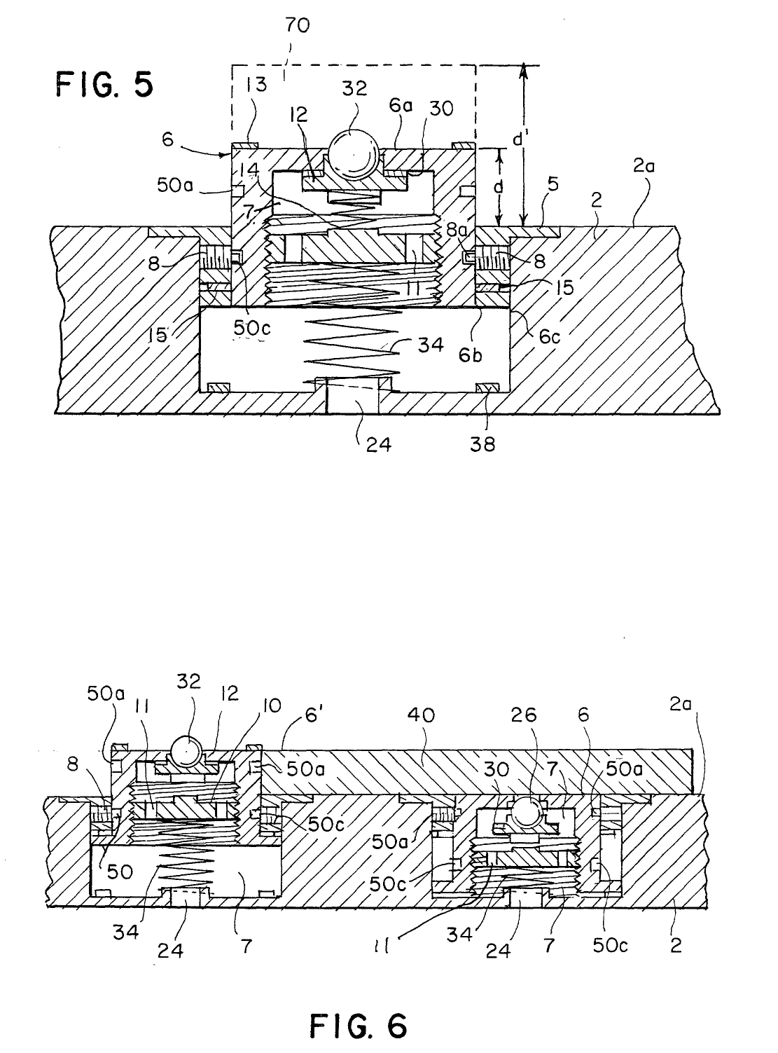

In accordance with an important feature of the invention, the cylindrical housing 6 is vertically displaceable from its illustrated flush position of FIG. 1 toward an elevated position shown in FIG. 5. More particularly, the housing 6 is normally biased upwardly relative to the work support 2 by a second compression spring 34 arranged between the tension adjusting disk 10 and the cavity bottom wall 3a. The housing 6 is retained in its FIG. 1 position against the force of the second compression spring 34 by a pair of pins 8a carried set screws 8 which extend inwardly into a corresponding pair of oppositely arranged grooves 50 provided in the outer peripheral wall of the housing 6, as best shown in FIG. 2A. More particularly, each groove 50 has a generally C-shaped configuration defining horizontal upper and lower leg portions 50a and 50c that are connected by a vertical portion 50b. Thus, in the FIG. 1 position, the housing 6 is maintained in the flush position by the cooperation between the pins 8a and the upper groove legs 50a, while in the FIG. 5 elevated position, the housing 6 is retained in position by the cooperation between the pins 8a and the lower horizontal groove portions 50c. The housing 6 is provided at its lower end with an annular peripheral flange 6c that cooperates with an annular third seal 15 that is arranged between the lower surface 5b of the mounting ring and the upper surface 6d of the flange 6c when the housing 6 is in the elevated position shown in FIG. 5, thereby to further seal the suction chamber 7. A fourth annular seal 13 is arranged on the upper surface 6a of the housing in concentrically spaced relation about the opening 26, thereby to provide a seal of the chamber defined around the opening when the sensor member 32 is depressed by a workpiece, as will be described in greater detail below.

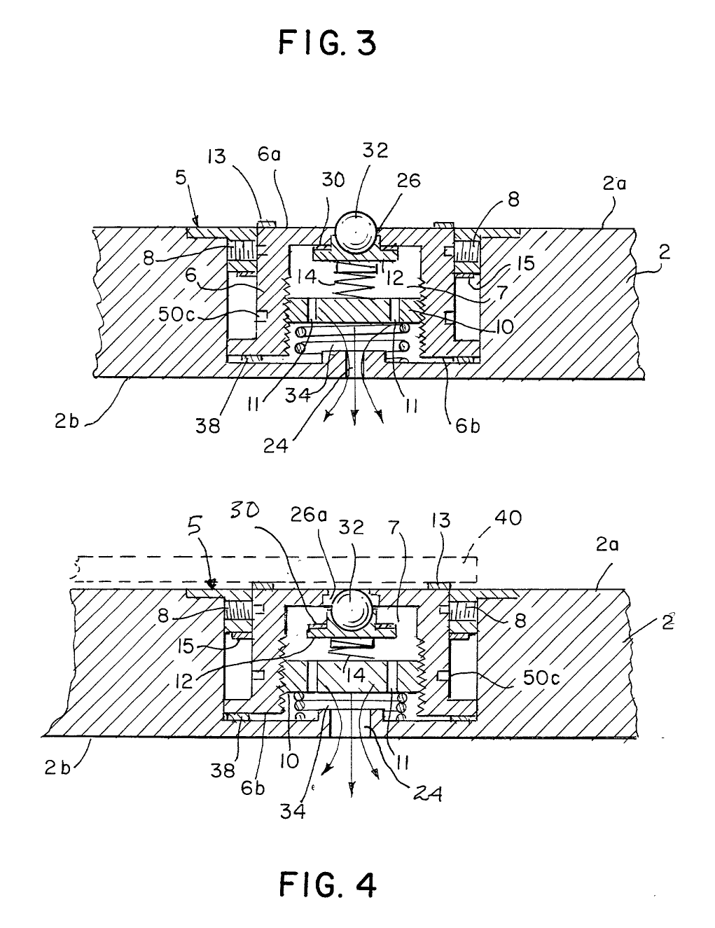

Referring now to FIGS. 3 and 4, it will be seen that when the curved portion of the sphere 32 that protrudes upwardly through the opening 26 is engaged by the workpiece 40 and is depressed against the restoring force of spring 14. the chamber defined between the workpiece 40 and the upper surface 6a of the housing 6 within the annular seal 13 is connected with the vacuum source via the channels 11 and opening 24, thereby to maintain the workpiece 40 by suction on the upper surface of the work support 2a at the desired machining location. The suction chamber 7 is further sealed by the cooperation of the annular seal 38 between the bottom surface 6b of the housing 6 and the bottom surface 3a of the cavity 3.

To elevate the housing from the flush position of FIGS. 1 and 3 to the elevated position of FIG. 5, the housing 6 is rotated through about 90° relative to the mounting ring 5 until the pins 8a are within the vertical portion 50b of the groove 50, whereupon the spring 34 biases the housing 6 upwardly toward the elevated position of FIG. 5. The housing 6 is then rotated about its axis in the opposite direction to cause the pin portions 8a of the set screws 8 to extend within the lower horizontal leg portions 50c of the slots 50, thereby maintaining the housing 6 in the elevated position of FIG. 5. As shown in FIG. 6, the left hand housing 6′ has been raised to its elevated position, thereby to serve as a stop for maintaining the workpiece 40 at a desired machining position on the upper surface 2a of the work support 2. As shown in FIG. 8, a plurality of the housing 6′ may be raised to their elevated positions, thereby to position a pair of workpieces 40 and 41 on the work support 2, as desired.

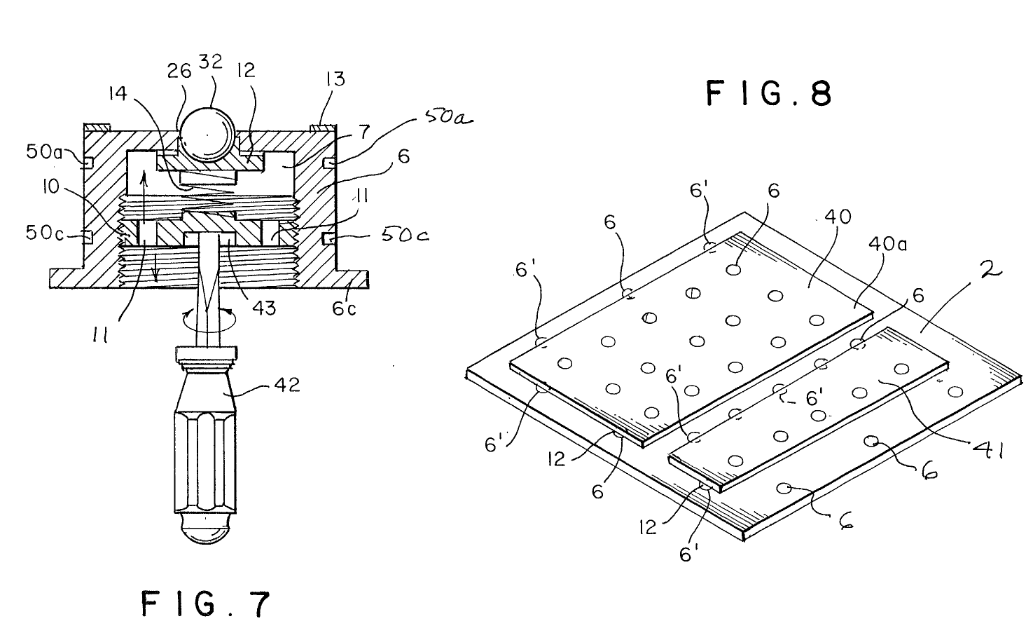

As shown in FIG. 7, the tension of the first spring 14 may be adjusted by means of screwdriver 42 engaging slot 43 in the bottom of the tension adjusting disk 10, thereby to rotate the same relative to the housing 6 and then adjust the tension of the first compression spring 14.

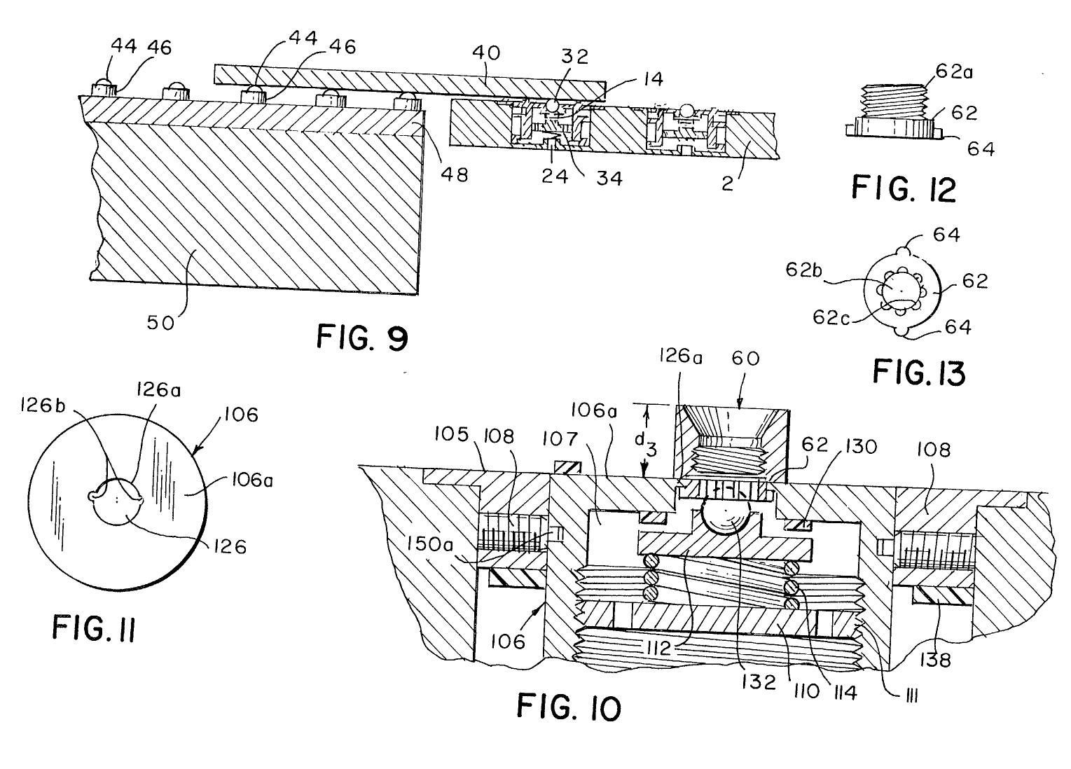

Referring now to FIG. 9, the workpiece 40 may be transported by transport conveyor means 50 having spherical members 44 supported by supports 46. The workpiece 40 is transported to a desired location on the work support 24 as determined by selectively operated stops 6′, whereupon the weight of the workpiece causes the spherical elements 32 of the other actuator means 6 to be lowered to their open positions. The shutoff valve 19 is then opened to establish vacuum in the associated vacuum chambers 7, thereby to maintain by suction the workpiece 40 on the work support 2.

Referring now to FIGS. 10-13, in accordance with another important feature of the invention, attachment means are provided for connecting an attachment 60 to the opening 26 contained in the upper end of the cylindrical housing 106. The connector 62 of FIG. 12 has a pair of lateral projections 64 that cooperate with diametrically opposed slots 126b contained in the inwardly directed lip portion 126a of opening 126, thereby to define a quick-release bayonet-type connection between the attachment member 60 and the opening 126. The attachment member 60 is threadably connected with the upper threaded portion 62a of the connector 62, whereupon the sphere 132 is opened from its seat, and the chamber 61 within the attachment 60 is connected with the vacuum chamber 107 by the axially directed flutes 62c on the inner periphery of the connector 62. Thus, the chamber 61 is connected with suction via the flute 62c and the space in the opening resulting from the downward displacement of the sphere 132 relative the cylindrical housing 106.

As shown in FIGS. 14-16, various types of attachments may be connected with the openings 26 and 126 of the cylindrical housings 6 and 106. For example, in the embodiment of FIG. 14, the attachment 70 contains a chamber 78 that is in communication with the vacuum chamber 107 of the housing 106, the attachment being provided with an annular seal 76 that extends concentrically around the attachment central chamber 78. In the embodiment of FIG. 15, the attachment 80 comprises a stop member that is selectively connected to the upper openings of either of the housings 6, 106 by a quick-release quarter-turn bayonet fitting. In the embodiment of FIG. 16. the attachment 90 comprises a suction cup having a resilient outwardly flared upper portion 90b that extends concentrically about the chamber 90a that communications with the suction chamber 7 in the associated housing 6 or 106.

As shown in FIG. 5, the effective height d of the upper surface 6a can be extended to the greater height d′ by the addition of the attachment 70, as shown in phantom. This is important when the various workpieces to be machined are of nonuniform thickness throughout their lengths or require special milling or drilling techniques. In any event, the workpiece may be supported by suction at the various suction stations and at various elevations as selectively chosen by the operator.

While in accordance with the provisions of the Patent Statutes the preferred forms and embodiments of the invention have been illustrated and described, it will be apparent to those skilled in the art that various changes may be made without deviating from the inventive concepts set forth above.

What is claimed is:

1. A vacuum holddown device for machining a workpiece, comprising:
(a) a horizontal planar work support (2) having planar upper (2a) and lower (2b) surfaces, said work support upper surface containing a plurality of vertical first cavities (3) that define a plurality of suction holddown stations, said vertical cavities having bottom walls (3a), said work support lower surface containing a plurality of openings (24) communicating with said vertical cavities, respectively;
(b) a plurality of actuator means mounted in said first cavities, respectively, each of said actuator means including:
(1) a vertically arranged cylindrical housing (6) having upper (6a) and lower (6b) end surfaces, said lower end surface containing a vacuum chamber (7) and said upper end surface containing a second opening (26) in communication with said vacuum chamber, said vacuum chamber being in continuous communication with the associated work support first opening;
(2) means normally clos.ng said second opening, including:
(a) a sensor member (32) arranged in said vacuum chamber for displacement between closed and open positions relative to said second opening;
(b) first spring means (14) biasing said sensor member toward said closed position;
(c) said sensor member in said closed position including a protruding portion with a rounded surface (32a) that protrudes through said second opening above said housing upper end surface;
(c) a vacuum source (16);
(d) connecting means connecting said vacuum source with each of said work support first openings, respectively, thereby to connect said vacuum chambers with said vacuum source via said first openings, respectively; and
(e) stop means arranged at selected first ones of said suction stations for positioning a workpiece at a given position on said work support upper surface, the remaining second ones of said suction holddown stations having sensor members that are depressed to their open positions by the workpiece, whereby the workpiece is retained by suction in said given position.

2. A vacuum holddown device as defined in claim 1, and further including:
(f) mounting means (5) mounting said cylindrical housing for vertical displacement relative to said work support between a lower flush position in which said housing upper end surface is coplanar with said work support upper surface, and an elevated position in which said housing upper end surface is elevated a given first distance (d) above said work support upper surface.

3. A vacuum holddown device as defined in claim 2, and further including:
(g) an attachment member (60; 70: 80; 90) removably connected with the second opening of a given housing in the elevated position, said attachment member having an upper surface (60a; 70a; 80a; 90a) that is spaced a second distance (d′) from said work support upper surface that is greater than said given first distance.

4. A vacuum holddown device as defined in claim 2, wherein said mounting means comprises:
(1) an annular mounting ring (5) arranged for relative sliding movement concentrically about said cylindrical housing, said mounting ring being supported by said work support and having an upper surface (5a) coplanar with said work support upper surface; and
(2) position adjustment means (8, 50) connecting said housing with said mounting ring for vertical adjustment between said lower flush and elevated positions, respectively.

5. A vacuum hoiddown device as defined in claim 4, wherein said position adjustment means comprises radially inwardly directed pin means (8) carried by the inner peripheral surface of said mounting ring, and slot means (50) carried by the outer peripheral surface of said cylindrical housing for receiving said pin means, said slot means having a generally C-shaped configuration including a pair of vertically-spaced horizontal leg portions (50a, 50c) joined by a vertical connecting portion (50b).

6. A vacuum holddown device as defined in claim 4, and further including second spring means (34) biasing said cylindrical housing upwardly relative to said work support.

7. A vacuum holddown device as defined in claim 6, wherein said first spring means is a first compression spring (14), and further including means for adjusting the tension of said first compression spring.

8. A vacuum holddown device as defined in claim 7, wherein said spring tension adjustment means comprises a perforated tension adjustment disk (10) threadably connected for vertical displacement relative to said housing, said first compression spring being arranged between said adjustment disk and said sensor member.

9. A vacuum holddown device as defined in claim 8, wherein said second spring means comprises a second compression spring (34) arranged between said tension adjustment disk and the bottom wall (36) of the associated cavity.

10. A vacuum holddown device as defined in claim 9, wherein said sensor member comprises a sphere (32), and further including a carrier member (12) supporting said sphere for rotation, said carrier member being arranged between said first compression spring and said sphere.

11. A vacuum holddown device as defined in claim 1, wherein said sensor member is a sphere; and further including a carrier supporting said sphere for rotation, said carrier being arranged between said first spring means and said sphere.

12. A vacuum holddown device as defined in claim 1, wherein said vacuum source connecting means includes a conduit (18) containing a shut-off valve (19), and a manifold (21) connecting said conduit with all of said work support first openings (24).

13. A vacuum holddown device as defined in claim 1, and further including:
(h) first annular seal means (30) for providing a seal between said sensor member and said cylindrical housing when said sensor member is in said closed position.

14. A vacuum holddown devise as defined in claim 13, and further including second annular seal means (38) arranged between said housing and the associated cavity bottom wall.

15. A vacuum holddown device as defined in claim 4, and further including:
(h) first annular seal means (30) for sealing said vacuum chamber when said sensor member is in said closed position;
(i) second annular seal means (38) arranged between said bottom end wall of said cylindrical housing and said cavity bottom wall when said housing is in said flush position; and
(j) third seal means (13) arranged on the upper end wall of said housing concentrically about said second opening.

16. A vacuum holddown device as defined in claim 15, wherein said cylindrical housing includes a lower end portion having an external annular flange portion (6c), and third annular seal means (15) arranged between said housing flange portion and said mounting ring for sealing said vacuum chamber when said housing is in said elevated position.

17. A vacuum holddown device as defined in claim 1, and further including:
(f) an attachment member (60; 70; 80; 90) arranged above the upper end wall of one of said cylindrical housings; and
(g) means (60a, 70a; 80a; 90a; 126a) connecting said attachment member with said cylindrical housing, said sensor member being operable to its open position when said attachment member is connected with said second opening.

18. A vacuum holddown device as defined in claim 17, wherein said attachment member comprises a stop member (80) for positioning the workpiece on the upper surface of said workpiece support.

19. A vacuum holddown device as defined in claim 17. wherein said attachment member contains a chamber in communication with said vacuum chamber when said attachment member is connected with said housing.

20. A vacuum holddown device as defined in claim 19, wherein said attachment member comprises a suction cup (90).
